(19) United States
(12) Patent Application Publication
(10) Pub. No.: US 2025/0130811 A1
(43) Pub. Date: Apr. 24, 2025

(54) Spill-After Programming Model for the Streaming Wave Coalescer

(71) Applicant: Advanced Micro Devices, Inc., Santa Clara, CA (US)

(72) Inventors: Sean Keely, Austin, TX (US); Kellie Marks, Sydney (AU)

(21) Appl. No.: 18/895,737

(22) Filed: Sep. 25, 2024

Related U.S. Application Data
(60) Provisional application No. 63/592,550, filed on Oct. 23, 2023.

(51) Int. Cl. G06F 9/38; G06F 15/80

(52) U.S. Cl. CPC G06F 9/3856; G06F 15/8061

(57) ABSTRACT

An apparatus and method for efficiently migrating the execution of threads between multiple parallel lanes of execution. In various implementations, a computing system includes multiple vector processing circuits of a compute circuit that executes multiple lanes of multiple waves. Each lane includes a key indicating a path of execution. When a lane of the multiple lanes of execution executes a stream wave coalescing (SWC) reorder instruction, a control circuit compares keys of waves that have previously executed the SWC reorder instruction. When the number of lanes with a matching key exceeds a threshold and after identifying at least this number of lanes to swap, the control circuit swaps continuation state information (live active state information) between lanes of an emitting wave that do not have a matching key and lanes of contributing waves that do have a matching key. The resulting (reordered) emitting wave executes more efficiently, which increases performance.

### CROSS REFERENCE TO RELATED APPLICATIONS

This application claims priority to Provisional Patent Application Ser. No. 63/592,550, entitled “Spill-After Programming Model for the Streaming Wave Coalescer” filed Oct. 23, 2023, the entirety of which is incorporated herein by reference.

### BACKGROUND

### Description of the Relevant Art

The parallelization of tasks is used to increase the throughput of computing systems. To this end, compilers extract parallelized tasks from applications to execute in parallel on the system hardware. To increase parallel execution on the hardware, many different types of computing systems include vector processing circuits or single-instruction, multiple-data (SIMD) circuits. Vector processing circuits, or SIMD circuits, include multiple parallel lanes of execution. Tasks can be executed in parallel on these types of parallel data processing circuits to increase the throughput of the computing system. The memory stores at least the instructions (or translated commands) of a parallel data application. The instructions are placed in kernels, each corresponding to a function call in the parallel data application. These types of micro-architectures provide higher instruction throughput for parallel data applications than a general-purpose micro-architecture. Tasks that benefit from the SIMD micro-architecture are used in a variety of applications in a variety of fields such as medicine, entertainment, engineering, social media, science, finance, and so on.

The throughput of the SIMD micro-architecture is highly dependent on the instructions filling the pipeline stages of the parallel execution lanes of the SIMD circuits. When a pipeline stage does not receive an instruction to process, the pipeline stage has a stall, or a “bubble,” inserted in it and no useful work is performed for that pipeline stage. For example, divergent points in execution cause one or more of the multiple parallel lanes of execution to become inactive. Divergent points in execution include a conditional control flow instruction being executed by the multiple parallel lanes of execution. Divergent points can also include unaligned memory accesses performed by the multiple parallel lanes of execution that do not target contiguous data storage locations. When many of the multiple parallel lanes of execution become inactive due to divergent points, performance reduces.

In view of the above, efficient methods and apparatuses for efficiently migrating the execution of threads between multiple parallel lanes of execution are desired.

### BRIEF DESCRIPTION OF THE DRAWINGS

FIG. 1 is a generalized diagram of a computing system that efficiently migrates the execution of threads between multiple parallel lanes of execution.

FIG. 2 is a generalized diagram of an apparatus that efficiently migrates the execution of threads between multiple parallel lanes of execution.

FIG. 3 is a generalized diagram of an apparatus that efficiently migrates the execution of threads between multiple parallel lanes of execution.

FIG. 4 is a generalized diagram of wave reordering that efficiently migrates the execution of threads between multiple parallel lanes of execution.

FIG. 5 is a generalized diagram of wave reordering that efficiently migrates the execution of threads between multiple parallel lanes of execution.

FIG. 6 is a generalized diagram of a method for efficiently migrating the execution of threads between multiple parallel lanes of execution.

FIG. 7 is a generalized diagram of a method for efficiently migrating the execution of threads between multiple parallel lanes of execution.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently migrating the execution of threads between multiple parallel lanes of execution are disclosed. In various implementations, a computing system includes a parallel data processing circuit that includes one or more compute circuits, each with multiple single instruction multiple data (SIMD) circuits. As used herein, a “SIMD” circuit can also be referred to as a “vector processing circuit.” Each of the SIMD circuits includes circuitry of multiple parallel lanes of execution. A particular combination of the same instruction and a particular data item of multiple data items is referred to as a “work item.” A work item is also referred to as a “thread.” Each of the multiple parallel lanes of the SIMD circuit executes a thread. In an implementation, a SIMD circuit with 32 parallel lanes of execution can simultaneously execute 32 threads.

The multiple work items (or multiple threads) are grouped into a “wavefront” or a “wave”, which is a partition of work executed in an atomic manner. In some implementations, a wavefront includes instructions of a function call (or subroutine) in a parallel data application. An instruction of the function call operates on multiple data items concurrently. Each data item is processed independently of other data items, but the same sequence of one or more operations of the instruction is used. Wavefronts are grouped into a “workgroup.” In an implementation, a compute circuit includes four SIMD circuits and receives a workgroup that includes four wavefronts. The scheduler of the compute circuit divides the received workgroup into four individual wavefronts and schedules each of the four wavefronts on one of the four SIMD circuits.

While executing the instructions of a wavefront, when a SIMD circuit executes a streaming wave coalescing (SWC) reorder instruction, a control circuit, such as the streaming wave coalescer (SWC) circuit, reorders lanes of execution across multiple wavefronts (multiple waves). The SWC circuit groups together lanes of waves that operate on the same path of execution. The same path of execution can include the next instruction and corresponding functional call to be executed by the lane. The resulting wave includes more lanes of execution that operate on the same path of execution while other lanes of execution that operate on a different path of execution were swapped to another wave. The operation of swapping lanes of execution between waves increases hardware resource efficiency and reduces the number of inactive lanes of execution across the multiple waves. Therefore, throughput of the compute circuit increases. In an implementation, each of the multiple lanes of execution of the resulting wave operates on the same first path of execution. It is possible and contemplated that another wave now has each of its multiple lanes of execution operating on the same second path of execution different from the first path of execution.

When grouping together multiple lanes of the multiple waves that operate on the same path of execution, the SWC circuit swaps lanes of execution between the multiple waves. Therefore, no new waves are created. Additionally, the SWC circuit does not swap (or exchange) continuation state information (live active state information) of the lanes of the waves until after the SWC circuit has already completed identifying which lanes of execution to swap between the multiple waves. To perform the swap of the continuation state information of a lane of a wave, the SWC circuit performs write operations, targeting a temporary data storage location, to create a copy of the continuation state information from one or more lanes of a first SIMD circuit executing a first wave. Each of these one or more lanes of the first SIMD circuit is a lane used in the swapping operation. This operation of creating the copy of the continuation state information in the temporary data storage location is referred to as a “spill” or performing “spilling.” Other lanes of the first SIMD circuit not used in the swapping operation maintain their copy of continuation state information. The SWC circuit additionally performs the spilling operation for lanes of other SIMD circuits in addition to the first SIMD circuit. Therefore, the swapping operation used to swap continuation state information can be used for lanes across multiple SIMD circuits. In some implementations, the swapping operation can also be used for lanes of multiple SIMD circuits of multiple compute circuits. The operation of retrieving the copy of the continuation state information from the temporary data storage location and storing it in a second SIMD circuit executing a second wave is referred as a “fill” or performing “filling.”

The SWC circuit performs the spill of the continuation state information after the SWC circuit has already completed identifying which lanes of execution of the multiple waves to swap between the multiple waves. This operation is referred to as performing a “spill-after” operation. Additionally, the SWC circuit performs the spill-after operation only for the lanes of the waves being swapped. When a SIMD circuit executes the SWC reorder instruction, should the SWC circuit first perform the spill of the continuation state information of all of the lanes of all of the waves, and then the SWC circuit identifies which lanes of execution to swap between the multiple waves, a larger amount of temporary data storage location is needed. If the SWC circuit performs the spill of the continuation state information before the SWC circuit identifies which lanes of execution to swap between the multiple waves, then the SWC circuit performs a “spill-before” operation.

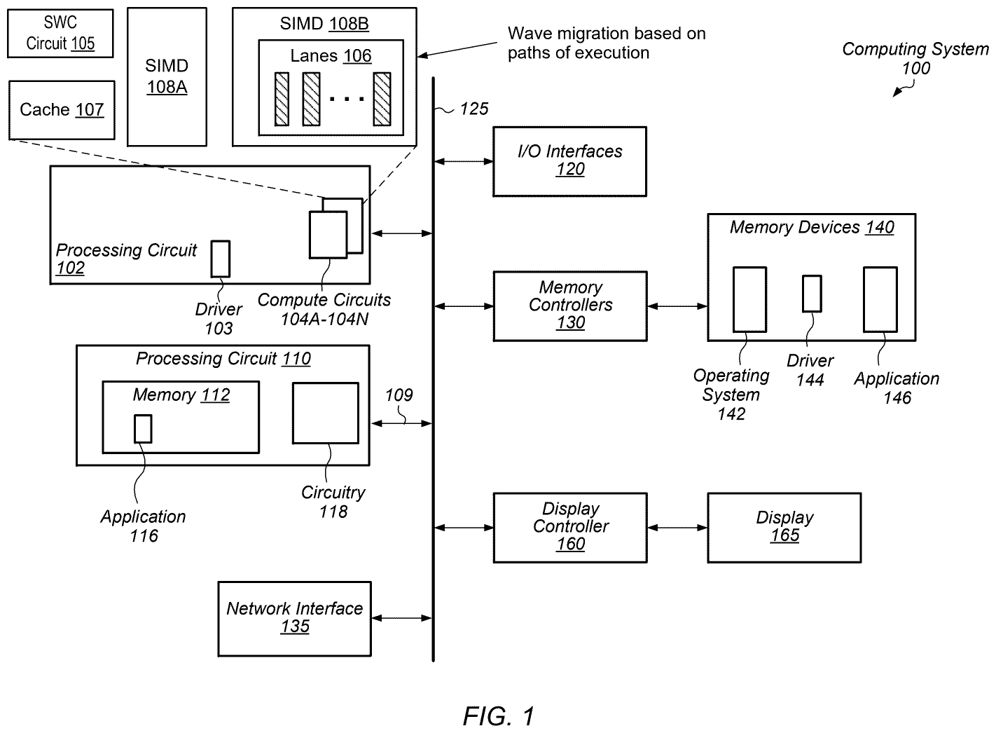

Besides requiring a larger amount of temporary data storage space when performing the spill-before operation, additionally, the number of memory access operations increase. Due to the larger number of memory access operations, the latency to complete identification of which lanes of execution to swap between the multiple waves increases, which also increases the latency of the SWC reorder instruction. The large amount of data storage space is also needed for a long duration of time while continuation state information of all lanes of all waves is being copied before the identification of which lanes of the waves to swap is begun. When the larger amount of temporary data storage space consumes cache data storage space or other data storage space storing other data required for the parallel data application, data is evicted and causes further increased latency to later retrieve the data from lower levels of the memory subsystem. To avoid these disadvantages, the SWC circuit performs the spill-after operation when executing the SWC reorder instruction. In some implementations, the SWC circuit performs the spill-after operation by swapping continuation state information within register files (vector register file and scalar register file), rather than creating copies of the continuation state information in a cache or other data storage space. Further details of these techniques for efficiently migrating the execution of threads between multiple parallel lanes of execution are provided in the following description of FIGS. 1-7.

Turning now to FIG. 1, a generalized diagram is shown of a computing system 100 that efficiently migrates the execution of threads between multiple parallel lanes of execution. In an implementation, computing system 100 includes at least processing circuits 102 and 110, input/output (I/O) interfaces 120, bus 125, network interface 135, memory controllers 130, memory devices 140, display controller 160, and display 165. In other implementations, computing system 100 includes other components and/or computing system 100 is arranged differently. For example, power management circuitry, and phased locked loops (PLLs) or other clock generating circuitry are not shown for ease of illustration. In various implementations, the components of the computing system 100 are on the same die such as a system-on-a-chip (SOC). In other implementations, the components are individual dies in a system-in-package (SiP) or a multi-chip module (MCM). A variety of computing devices use the computing system 100 such as a desktop computer, a laptop computer, a server computer, a tablet computer, a smartphone, a gaming device, a smartwatch, and so on.

Processing circuits 102 and 110 are representative of any number of processing circuits which are included in computing system 100. In an implementation, processing circuit 110 is a general-purpose central processing unit (CPU). In one implementation, processing circuit 102 is a parallel data processing circuit with a highly parallel data microarchitecture, such as a GPU. The processing circuit 102 can be a discrete device, such as a dedicated GPU (dGPU), or the processing circuit 102 can be integrated (an iGPU) in the same package as another processing circuit. Other parallel data processing circuits that can be included in computing system 100 include digital signal processing circuits (DSPs), field programmable gate arrays (FPGAs), application specific integrated circuits (ASICs), and so forth.

In various implementations, the processing circuit 102 includes multiple, replicated compute circuits 104A-104N, each including similar circuitry and components such as a single instruction multiple data (SIMD) circuits 108A-108B, the cache 107, and hardware resources (not shown). The hardware resources include at least an assigned number of vector general-purpose registers (VGPRs) per thread, an assigned number of scalar general-purpose registers (SGPRs) per wavefront, and an assigned data storage space of a local data store per workgroup. SIMD circuit 108A includes replicated circuitry of the circuitry of the SIMD circuit 108B. Although two SIMD circuits are shown, in other implementations, another number of SIMD circuits is used based on design requirements. As shown, the SIMD circuit 108B includes multiple, parallel computational lanes 106 (or parallel execution lanes 106). Cache 107 can be used as a shared last-level cache in a compute circuit.

In various implementations, the data flow of SIMD circuit 108B is pipelined and the parallel execution lanes 106 operate in lockstep. In various implementations, the circuitry of each of the parallel execution lanes 106 is an instantiated copy (or replicated copy) of circuitry for arithmetic logic units (ALUs) that perform integer arithmetic, floating-point arithmetic, Boolean logic operations, branch condition comparisons, and so forth. Each of the ALUs within a given row across parallel execution lanes 106 includes the same circuitry and functionality, and operates on the same instruction, but different data, such as a different data item, associated with a different thread. Pipeline registers are used for storing intermediate results.

Tasks performed by parallel execution lanes 106 can be grouped into a “workgroup” that includes multiple thread groups (or multiple wavefronts or multiple waves). Each of the compute circuits 104A-104N processes an assigned workgroup, and each of the SIMD circuits 108A-108B processes an assigned wavefront (or wave). The hardware, such as circuitry, of a scheduler (not shown) divides the workgroup into separate wavefronts and assigns the wavefronts to be dispatched to SIMD circuits 108A-108B. In an implementation, such a scheduler is a command processing circuit of a GPU. In various implementations, the scheduler receives the wavefronts for one of the compute circuits 104A-104N from a ring buffer implemented in data storage space of the memory devices 140, and schedules instructions of these wavefronts to be issued to SIMD circuits 108A-108B.

In some implementations, each of the application 146 stored on the memory devices 140 and its copy (application 116) stored on the memory 112 is a highly parallel data application. The highly parallel data application includes function calls that allow the developer to insert requests in the highly parallel data application for launching wavefronts of a kernel (function call). In various implementations, circuitry 118 of the processing circuit 110 converts (translates) the instructions of the highly parallel data application to commands. In various implementations, the processing circuit 110 stores the commands in a ring buffer in system memory provided by memory devices 140. Processing circuit 102 reads the commands from the ring buffer in the system memory provided by memory devices 140. In an implementation, the ring buffer includes multiple storage locations of the memory devices 140 used to provide a memory mapped input/output (MMIO) first-in-first-out (FIFO) buffer.

In some implementations, application 104 is a highly parallel data application that provides multiple kernels to be executed on the compute circuits 104A-104N. The high parallelism offered by the hardware of the compute circuits 104A-104N is used for real-time data processing. Examples of real-time data processing are rendering multiple pixels, image blending, pixel shading, vertex shading, and geometry shading. In such cases, each of the data items of a wavefront is a pixel of an image. The compute circuits 104A-104N can also be used to execute other threads that require operating simultaneously with a relatively high number of different data elements (or data items). Examples of these threads are threads for scientific, medical, entertainment, finance and encryption/decryption computations.

When a pipeline stage of parallel execution lanes 106 does not receive an instruction to process, the pipeline stage has a stall, or a “bubble,” inserted in it and no useful work is performed for that pipeline stage. For example, divergent points in execution cause one or more of the multiple parallel execution lanes 106 to become inactive. The instructions of the wavefront can cause divergence by including a conditional control flow instruction. Examples of the conditional control flow instruction are a conditional branch instruction in an if-elseif-else construct, an if-else construct, a case construct and so forth. Multiple trace paths are traversed during execution of the translated and compiled program instructions between the divergent point and a corresponding convergent point. When many of the multiple parallel execution lanes 106 traverse a different trace path from other parallel lanes of execution, many of the multiple parallel execution lanes 106 become inactive and performance reduces. Divergent points can also include unaligned memory accesses performed by parallel execution lanes 106 that do not target contiguous data storage locations.

To increase throughput of processing circuit 102 despite divergence occurring during execution of wavefronts (or waves), streaming wave coalescer (SWC) circuit 105 supports swapping lanes of waves to generate new waves that include more lanes of execution that operate on the same path of execution. The operation of swapping lanes of execution between waves increases hardware resource efficiency of parallel execution lanes 106 of compute circuits 104A-104N and reduces the number of inactive lanes across the multiple waves. Therefore, throughput of the compute circuits 104A-104N increases. SWC circuit 105 also supports a spill-after operation, rather than a spill-before operation, when swapping lanes between the multiple waves. By doing so, SWC circuit 105 reduces the amount of temporary data storage space required to swap continuation state information (live active state information) of the lanes of the waves and reduces the amount of time required to maintain the temporary data storage. Although SWC circuit 105 is shown as being included in each of the compute circuits 104A-104N, in other implementations, a single SWC circuit is shared by multiple compute circuits 104A-104N.

Streaming wave coalescing (SWC) reorder instructions are inserted in a parallel data application such as application 116. In some implementations, this SWC reorder instruction is a function call within the parallel data application (application 116). When a lane of parallel execution lanes 106 includes a thread corresponding to a lane of a wave that executes the SWC reorder instruction, then the SWC circuit 105 of a corresponding one of the compute circuits 104A-104N begins swapping lanes across multiple waves while using the spill-after operation. To do so, SWC circuit 105 identifies which lanes across the multiple waves will execute the same path of execution.

To identify which lanes across the multiple waves will execute the same path of execution, in some implementations, SWC circuit 105 compares keys of the lanes of the multiple waves. The keys are data values that indicate the upcoming paths of execution for the lanes of the multiple waves. For a particular lane of the multiple waves, the key indicates a next instruction to execute and the corresponding functional call to be executed by the lane. In an implementation, the key is at least a subset, such as a least-significant portion, of an instruction pointer indicating the next instruction to execute and the corresponding functional call to be executed by the lane. As used herein, a “pointer” is an address or other information used to identify a data storage location. In another implementation, the key is a combination of at least a portion of the instruction pointer and one or more other data values combined by one of a variety of types of a hash algorithm. In some implementations, when executing the parallel data application (application 116), the host processing circuit, such as processing circuit 110, generates the keys of the lanes of the multiple waves. As used herein, the “key” can also be referred to as the “sort key.”

SWC circuit 105 receives or retrieves the keys of the multiple waves executing on one or more of the compute circuits 104A-104N. In some implementations, SWC circuit 105 is capable of accessing information in other compute circuits, or a single SWC circuit 105 is shared by multiple compute circuits of compute circuits 104A-104N. In some implementations, SWC circuit 105 selects, as the first key, the key of the lane with the thread that executed the SWC reorder instruction. In another implementation, the SWC reorder instruction specifies the first key to use for the comparisons. SWC circuit 105 compares the first key to the keys of other lanes that have previously executed the SWC reorder instruction. These lanes providing a key for the comparison and have previously executed the SWC reorder instruction are from SIMD circuits of the same compute circuit and can be from SIMD circuits of other compute circuits based on the hardware configuration.

In an implementation, if each of Lane 7 of Wave 2 with Key 38 and Lane 22 of Wave 4 with Key 119 have executed the SWC reorder instruction, SWC circuit 105 compares Key 38 and Key 119 with the keys of each of the lanes of each of the waves within a same compute circuit of compute circuits 104A-104N that have previously executed the SWC reorder instruction. In another implementation, SWC circuit 105 compares Key 38 and Key 119 with the keys of each of the lanes of each of the waves within one or more compute circuits of compute circuits 104A-104N that have previously executed the SWC reorder instruction. Similarly, the keys of the other lanes that have previously executed the SWC reorder instruction have been compared with keys amongst these lanes currently executing on a corresponding one of the compute circuits 104A-104N. In other implementations, SWC circuit 105 compares Key 38 and Key 119 with the keys of each of the lanes of each of the waves currently executing on each of the compute circuits 104A-104N.

In yet other implementations, SWC circuit 105 compares each of the keys to the other keys. Therefore, if SIMD circuits 108A-108D have four SIMD circuits, each with 32 parallel execution lanes 106, then there can be a maximum of 4 waves simultaneously executing in a compute circuit of compute circuits 104A-104N and there are 128 (4×32) threads simultaneously executing in the compute circuit. If 43 lanes (threads) have executed the SWC reorder instruction in this compute circuit, SWC circuit 105 compares each of the 43 keys to one another. Of the total number of 43 keys, if SWC circuit 105 determines there are 10 unique keys, then these 10 unique keys represent 10 unique paths of execution on SIMD circuits 108A-108D among these 43 lanes that have executed the SWC reorder instruction. In another implementation, SWC circuit 105 is shared by more than one compute circuit of compute circuits 104A-104N and SWC circuit compares keys for a greater number of lanes (threads) that have executed the SWC reorder instruction.

The SWC circuit 105 generates a number (or a count) of lanes of the multiple waves with a key matching the first key such as Key 38. For example, SWC circuit 105 sums the number of lanes of the multiple waves with a key matching the first key such as Key 38. If the number of lanes with a matching key to Key 38 is equal to or greater than a threshold number, then SWC circuit 105 exchanges (swaps) active state information between one or more pairs of lanes from at least two waves of the multiple waves. For example, SWC circuit 105 selects a wave to be a first emitting wave that will include lanes across the multiple waves that use the first key (Key 38). In an implementation, the emitting wave is a wave with more lanes using Key 38 than any other wave. Similarly, SWC circuit 105 generates a number (or a count) of lanes of the multiple waves with a key matching Key 119. If the number of lanes with a matching key to Key 119 is equal to or greater than a threshold number, then SWC circuit 105 selects a wave to be a second emitting wave that will include lanes across the multiple waves that use Key 119.

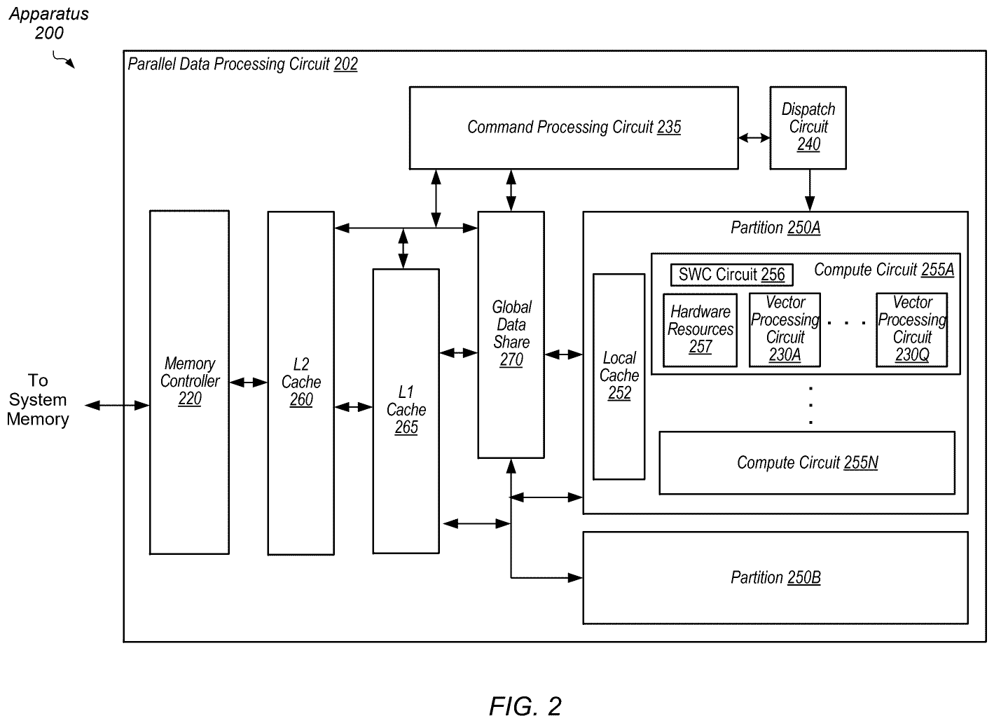

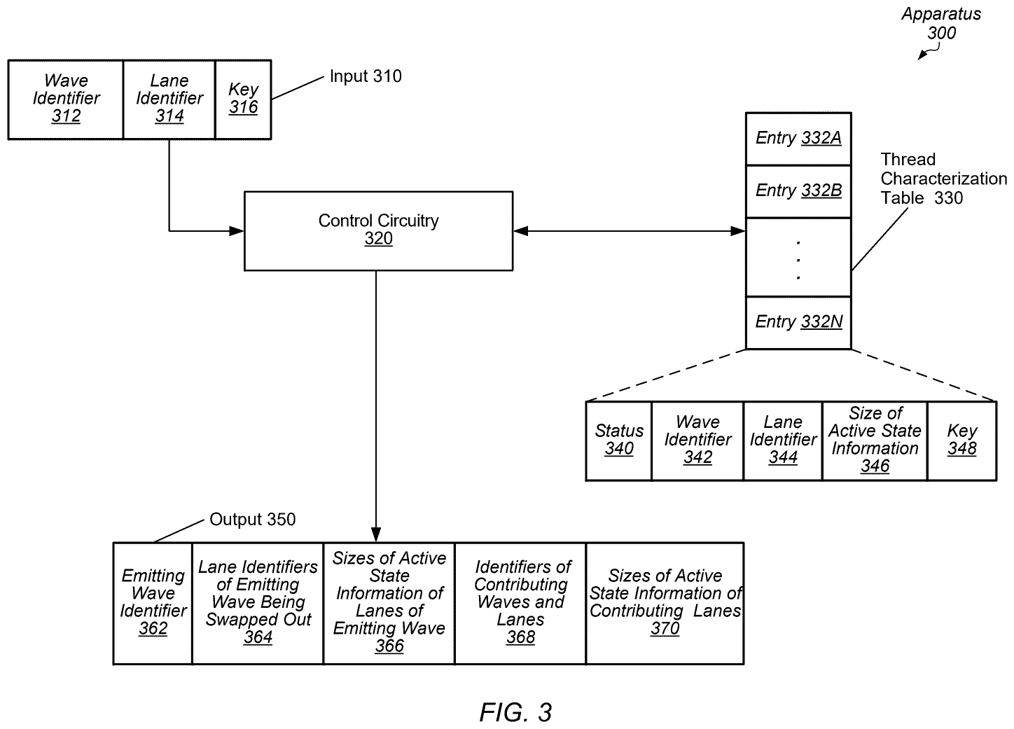

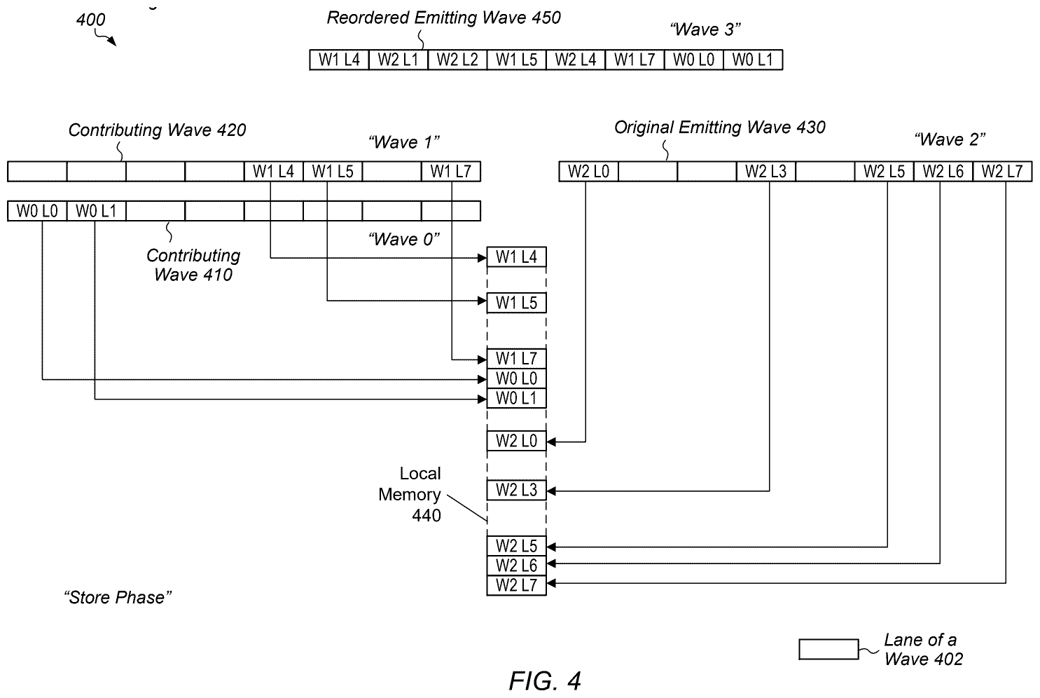

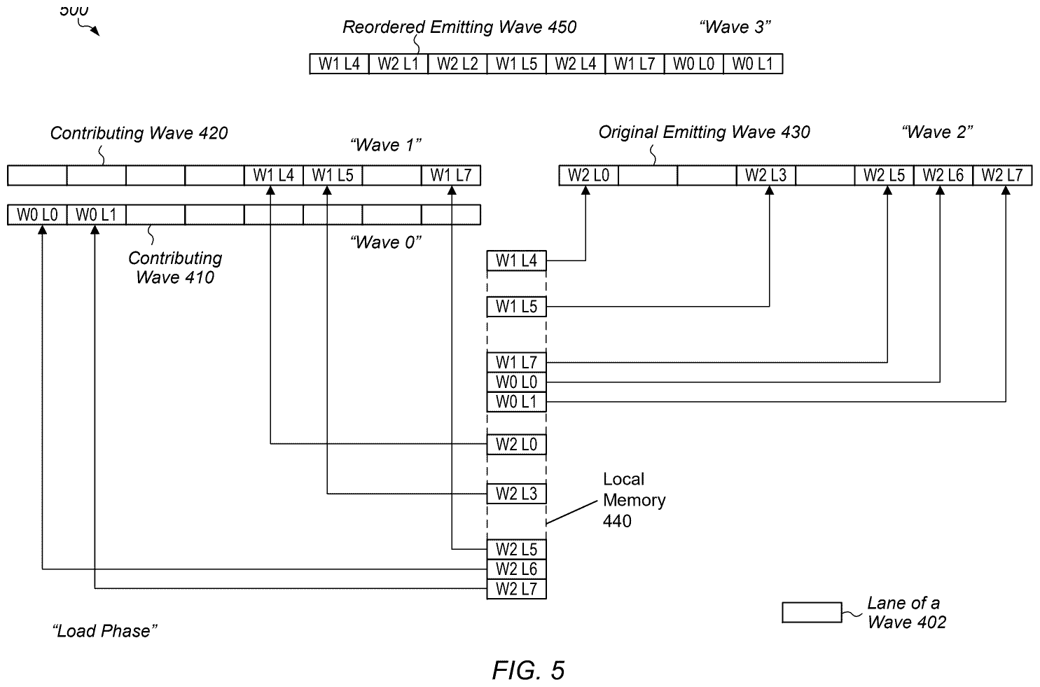

For one or more lanes of the first emitting wave with a key that does not match the first key (Key 38), one or more of the SWC circuit 105 and control circuitry in the corresponding compute circuit swaps continuation state information (live active state information). It is noted that in the following description, steps described as being performed by SWC circuit 105 can also be performed by other control circuitry in the corresponding compute circuit of compute circuits 104A-104N. The swapping of continuation state information includes lanes of other waves that do have a matching key (a key matching Key 38). These other waves that do have a matching key (a key matching Key 38) are referred to as “contributing waves.” Using the spill-after operation, SWC circuit 105 swaps the continuation state information after identifying the first emitting wave. The resulting (reordered) first emitting wave executes more efficiently, which increases performance. Similarly, for each lane of the second emitting wave with a key that does not match the second key (Key 119), the SWC circuit 105 swaps continuation state information (live active state information) between lanes of the second emitting wave that do not have a matching key and lanes of contributing waves that do have a matching key (a key matching Key 119). SWC circuit 105 swaps the continuation state information after identifying the second emitting wave using the spill-after operation. The SWC circuit 105 performs one or more of the steps and has corresponding lanes of the emitting wave and the contributing waves perform other steps by executing function calls (calling the functions). In some implementations, SWC circuit 105 and the emitting waves perform the steps of the spill-after operation with the contributing waves not performing any of the steps. In an implementation, the SWC circuit 105 executes instructions of driver 103 to perform steps and assign steps to perform the wave reordering. Further details are provided in the description of the apparatus 200 (of FIG. 2), the apparatus 300 (of FIG. 3), and the wave reordering 400-500 (of FIGS. 4-5).

Memory 112 represents a local hierarchical cache memory subsystem. Memory 112 stores source data, intermediate results data, results data, and copies of data and instructions stored in memory devices 140. Processing circuit 110 is coupled to bus 125 via interface 109. Processing circuit 110 receives, via interface 109, copies of various data and instructions, such as the operating system 142, one or more device drivers such as device driver 144, one or more applications such as application 104, and/or other data and instructions. The processing circuit 110 retrieves a copy of the application 104 from the memory devices 140, and the processing circuit 110 stores this copy as application 116 in memory 112.

In some implementations, computing system 100 utilizes a communication fabric (“fabric”), rather than the bus 125, for transferring requests, responses, and messages between the processing circuits 102 and 110, the I/O interfaces 120, the memory controllers 130, the network interface 135, and the display controller 150. When messages include requests for obtaining targeted data, the circuitry of interfaces within the components of computing system 100 translates target addresses of requested data. In some implementations, the bus 125, or a fabric, includes circuitry for supporting communication, data transmission, network protocols, address formats, interface signals and synchronous/asynchronous clock domain usage for routing data.

Memory controllers 130 are representative of any number and type of memory controllers accessible by processing circuits 102 and 110. While memory controllers 130 are shown as being separate from processing circuits 102 and 110, it should be understood that this merely represents one possible implementation. In other implementations, one of memory controllers 130 is embedded within one or more of processing circuits 102 and 110 or it is located on the same semiconductor die as one or more of processing circuits 102 and 110. Memory controllers 130 are coupled to any number and type of memory devices 140.

Memory devices 140 are representative of any number and type of memory devices. For example, the type of memory in memory devices 140 includes Dynamic Random Access Memory (DRAM), Static Random Access Memory (SRAM), NAND Flash memory, NOR flash memory, Ferroelectric Random Access Memory (FeRAM), or otherwise. Memory devices 140 store at least instructions of an operating system 142, one or more device drivers, and application 104. In some implementations, application 104 is a highly parallel data application such as a video graphics application, a shader application, or other. Copies of these instructions can be stored in a memory or cache device local to processing circuit 110 and/or processing circuit 102.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 receives and sends network messages across a network.

Turning now to FIG. 2, a block diagram is shown of an apparatus 200 that efficiently migrates the execution of threads between multiple parallel lanes of execution. In one implementation, apparatus 200 includes parallel data processing circuit 202 with an interface to system memory. In an implementation, parallel data processing circuit 202 is a graphics processing unit (GPU). In various implementations, apparatus 200 executes any of various types of highly parallel data applications. As part of executing an application, a host CPU (not shown) launches kernels to be executed by the parallel data processing circuit 202. The command processing circuit 235 receives kernels from the host CPU and determines when dispatch circuit 240 dispatches wavefronts of these kernels to the compute circuits 255A-255N.

Multiple processes of a highly parallel data application provide work to be executed on compute circuits 255A-255N. The parallel data processing circuit 202 includes at least the command processing circuit (or command processor) 235, dispatch circuit 240, compute circuits 255A-255N, memory controller 220, global data share 270, shared level one (L1) cache 265, and level two (L2) cache 260. It should be understood that the components and connections shown for the parallel data processing circuit 202 are merely representative of one type processing circuit and does not preclude the use of other types of processing circuits for implementing the techniques presented herein. The apparatus 200 also includes other components which are not shown to avoid obscuring the figure. In other implementations, the parallel data processing circuit 202 includes other components, omits one or more of the illustrated components, has multiple instances of a component even if only one instance is shown in the apparatus 200, and/or is organized in other suitable manners. Also, each connection shown in apparatus 200 is representative of any number of connections between components. Additionally, other connections can exist between components even if these connections are not explicitly shown in apparatus 200.

In an implementation, the memory controller 220 directly communicates with each of the partitions 250A-250B and includes circuitry for supporting communication protocols and queues for storing requests and responses. Threads within wavefronts executing on compute circuits 255A-255N read data from and write data to the cache 252, vector general-purpose registers, scalar general-purpose registers, and when present, the global data share 270, the shared L1 cache 265, and the L2 cache 260. When present, it is noted that the shared L1 cache 265 can include separate structures for data and instruction caches. It is also noted that global data share 270, shared L1 cache 265, L2 cache 260, memory controller 220, system memory, and cache 252 can collectively be referred to herein as a “cache memory subsystem”.

In various implementations, the circuitry of partition 250B is a replicated instantiation (or replicated copy or replicated instance) of the circuitry of partition 250A. In some implementations, each of the partitions 250A-250B is a chiplet. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

In an implementation, cache 252 represents a last level shared cache structure such as a local level-two (L2) cache within partition 250A. Additionally, each of the multiple compute circuits 255A-255N includes vector processing circuits 230A-230Q, each with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread.

In addition to the vector processing circuits 230A-230Q, compute circuit 255A also includes the hardware resources 257. The hardware resources 257 include at least an assigned number of vector general-purpose registers (VGPRs) per thread, an assigned number of scalar general-purpose registers (SGPRs) per wavefront, and an assigned data storage space of a local data store per workgroup. Each of compute circuits 255A-255N receives wavefronts from dispatch circuit 240 and stores the received wavefronts in an instruction buffer of a corresponding local dispatch circuit (not shown). A local scheduler (not shown) within compute circuits 255A-255N schedules instructions of these wavefronts to be dispatched from the local dispatch circuits to the vector processing circuits 230A-230Q. Cache 252 can be the last level shared cache structure of the partition 250A.

When a pipeline stage of parallel execution lanes of vector processing circuits 230A-230Q does not receive an instruction to process, the pipeline stage has a stall, or a “bubble,” inserted in it and no useful work is performed for that pipeline stage. For example, divergent points in execution cause one or more of the multiple parallel lanes of vector processing circuits 230A-230Q to become inactive. As described earlier, sources of divergence include conditional control flow instructions in the wavefronts and unaligned memory accesses that do not target contiguous data storage locations. To increase throughput of partition 250A despite divergence occurring during execution of wavefronts (or waves), streaming wave coalescer (SWC) circuit 256 supports swapping lanes of waves to provide waves that include more lanes of execution that operate on the same path of execution. SWC circuit 256 also supports a spill-after operation, rather than a spill-before operation, when swapping lanes between the multiple waves. By doing so, SWC circuit 256 reduces the amount of temporary data storage space required to swap continuation state information (live active state information) of the lanes of the waves and reduces the amount of time required to maintain the temporary data storage. By reducing this amount of time, other sources using the temporary data storage experience less contention.

If a lane of the multiple waves executes a stream wave coalescing (SWC) reorder instruction, then in an implementation, SWC circuit 256 obtains keys for the lanes of the multiple waves executing on compute circuit 255A. In other implementations, SWC circuit 256 obtains keys for the lanes of the multiple waves executing on compute circuits 255A-255N. It is noted that although SWC circuit 256 is shown as being located within compute circuit 255A, in other implementations, SWC circuit 256 is located outside compute circuit 255A, but within partition 250A. In some implementations, SWC circuit 256 obtains keys by retrieving them, whereas in other implementations, SWC circuit 256 receives the keys from the lane that executed the SWC reorder instruction. Each key indicates a path of execution. In some implementations, the key includes at least a subset, such as a least-significant portion of an instruction pointer, indicating a next instruction and corresponding functional call to be executed by the lane. In another implementation, the key is a combination of at least a portion of the instruction pointer and one or more other data values combined by one of a variety of types of a hash algorithm. In some implementations, when executing the parallel data application, the host processing circuit generates the keys of the lanes of the multiple waves. SWC circuit 256 compares one or more of the retrieved keys with the other keys of the retrieved keys.

For a particular key, SWC circuit 256 generates a number of lanes of the multiple waves with a key matching this particular key. If the number of lanes is equal to or greater than a threshold number, then SWC circuit 256 selects a wave to be an emitting wave that will include lanes across the multiple waves that use this particular key. In an implementation, the emitting wave is the wave that includes the lane with the particular key that executed the SWC reorder instruction. In another implementation, the emitting wave is a wave with more lanes using the particular key than any other wave. In other implementations, the emitting wave is selected using a variety of other criteria. It is possible and contemplated that the emitting wave has no original lanes with the particular key, and thus, each lane of the emitting wave needs to have a swapping operation performed with its corresponding continuation state information. For one or more lanes of the emitting wave with a key that does not match the key used to select the emitting wave, the SWC circuit swaps wave identifiers (IDs) and lane identifiers (IDs) with lanes of other waves (contributing waves) that have a key that does match the key used to select the emitting wave. Examples of the emitting wave are the emitting wave 430 (of FIGS. 4-5) and examples of the contributing waves are contributing waves 410 and 420 (of FIGS. 4-5). The SWC circuit 256 sends a data structure that stores the swapped wave IDs and lane IDs to the emitting wave as a result of the streaming wave coalescing (SWC) reorder instruction. Using the data structure, the lanes of the waves and the SWC circuit 256 swap continuation state information (live active state information) to place, into the emitting wave, the lanes of the contributing waves that use the matching key. Using the spill-after operation, one or more of the SWC circuit 256 and control circuitry within the corresponding vector processing circuit (SIMD circuit) or corresponding compute circuit swaps the continuation state information after identifying the second emitting wave. The resulting (reordered) emitting wave executes more efficiently, which increases performance.

Turning now to FIG. 3, a generalized diagram is shown of an apparatus 300 that efficiently migrates the execution of threads between multiple parallel lanes of execution. In various implementations, apparatus 300 includes the functionality of a control circuit such as streaming wave coalescer (SWC) circuit 105 (of FIG. 1) and SWC circuit 256 (of FIG. 2). As shown, apparatus 300 includes control circuitry 320 and thread characterization table 330 (or table 330). Control circuitry 320 receives input 310, accesses table 330 and generates output 350. Although particular information is shown as being stored in the fields 312-316 of input 310, in fields 340-348 of entries 332A-332N, and fields 362-370 of output 350, and in a particular contiguous order, in other implementations, a different order is used, and a different number and type of information is stored.

Control circuitry 320 receives input 310 when one of the lanes of the multiple waves executes the stream wave coalescing (SWC) reorder instruction. Field 312 stores the unique wave identifier (ID) of a wave. Field 314 stores the unique lane identifier (ID), which can be an indication of the lane's position within the wave or other identification. Field 316 stores a key that indicates the current or next path of execution of the lane. In some implementations, the key includes at least a subset, such as a least-significant portion of an instruction pointer indicating a next instruction and corresponding functional call to be executed by the lane. In another implementation, the key is a combination of at least a portion of the instruction pointer and one or more values combined by one of a variety of types of a hash algorithm. In an implementation, the SWC reorder instruction specifies the key value in field 316 to use for the comparisons.

Entries 332A-332N of table 330 are implemented by a hardware data structure that utilizes one of flip-flop circuits, a random-access memory (RAM), a content addressable memory (CAM), or other circuitry. Access circuitry for table 330 is not shown. As shown, field 340 stores status information such as at least a valid bit indicating valid information is stored in an allocated entry. Field 342 stores a wave ID of a corresponding wave being executed by one of parallel lanes of a corresponding vector processing circuit. Field 344 stores a lane ID of the lane executing the wave specified by the wave ID in field 342. Field 346 stores an indication of an amount or size of the active state information of the thread being executed by the lane specified by the lane ID in field 344. Field 348 stores a currently used key of the thread being executed by the lane specified by the lane ID in field 344.

Control circuitry 320 compares the value of key 316 to the values of the key in field 348 in entries 322A-322N. Control circuitry 320 generates a number of entries of entries 332A-332N with a key 348 matching the key 316. If the number of lanes is less than a threshold number, then control circuitry 320 waits while the compute circuit continues executing other waves on the multiple vector processing circuits. After a time interval has elapsed, control circuitry 320 performs the comparisons again, but entries 332A-332N have updated values for the key in field 348 based on the execution of the corresponding threads by the multiple parallel lanes of the vector processing circuits of the compute circuit. In some implementations, control circuitry 320 includes configuration and status registers (CSRs) that can store a programmable threshold and a programmable time interval.

In some implementations, input 310 is received for only lanes that have executed the SWC reorder instruction. In other implementations, input 310 is received for each lane of each wave with a unique key. If a compute circuit has four SIMD circuits, each with 32 parallel lanes, then there can be a maximum of 4 waves simultaneously executing in a compute circuit and there are 128 threads (32 threads per SIMD circuit×4 SIMD circuits) simultaneously executing in the compute circuit. If 43 lanes (threads) have executed the SWC reorder instruction in this compute circuit, control circuitry 320 compares each of the 43 keys to one another. Of the total number of 43 keys, if control circuitry 320 determines there are 10 unique keys, then these 10 unique keys represent 10 unique paths of execution in the compute circuit among these 43 lanes that have executed the SWC reorder instruction. In another implementation, apparatus 300 compares keys of lanes across multiple compute circuits such as compute circuits 255A-255N in partition 250A of apparatus 200 (of FIG. 2). If apparatus 300 compares keys of lanes of four compute circuits, then there are 512 lanes (threads) (32 threads per SIMD circuit×4 SIMD circuits per compute circuit×4 compute circuits) that can possibly execute the SWC reorder instruction and provide a key for comparisons. In an implementation, table 330 has as many entries 332A-332N as the supported number of keys to compare with key 316 of input 310.

Although table 330 is shown as a single table, in various implementations, table 330 is divided into multiple smaller tables to support simultaneous comparisons with each comparison using a smaller number of entries of the total number of entries 332A-332N. If there are 12 unique keys among the 128 keys (or 512 keys or another total number of keys) representing 12 unique paths of execution on the SIMD circuits, then in an implementation, apparatus 300 compares each of the 12 keys to the key in field 348 of the entries 332A-332N. Therefore, apparatus 300 receives 12 different inputs 310. For a particular key in field 316 in a received input 310, in an implementation, apparatus 300 stops the comparisons for the particular key when the threshold number of matches among keys in field 348 of entries 332A-332N has been reached or exceeded. In an implementation, control circuitry 320 updates a corresponding one of entries 332A-332N each time a lane of the multiple waves has an updated thread, which includes an updated key.

When the number of lanes (number of entries 322A-322N) with a key matching the key in field 316 of input 310 is equal to or greater than the threshold number, then control circuitry 320 selects a wave to be the emitting wave. Control circuitry 320 selects a wave to be the emitting wave that will include lanes across the multiple waves that use the key in field 316. In an implementation, the emitting wave is the wave that includes the lane with the thread that executed the SWC reorder instruction. In another implementation, the emitting wave is a wave with more lanes using the key in field 316 than any other wave.

For each lane of the emitting wave with a key stored in field 348 that does not match key 316, control circuitry 320 swaps wave identifiers (IDs) and lane identifiers (IDs) with lanes of other waves (contributing waves) that have a key 348 that does match the key 316. Control circuitry 320 sends a data structure that stores the swapped wave IDs and lane IDs to the emitting wave as a result of the wave coalescing reorder instruction. For example, control circuitry 320 sends output 350 to the emitting wave. Field 362 stores the emitting wave identifier (ID). Field 364 stores indications, such as lane IDs, of the lanes of the emitting wave being swapped out. Field 366 stores indications of the sizes of the active state information of the lanes specified in field 364. Field 368 stores identifiers of the contributing waves and the lanes of the contributing waves to be used to swap continuation state information with lanes of the emitting wave specified in field 364. Field 370 stores indications of the sizes of the active state information of the lanes specified in field 368.

Referring to FIG. 4, a generalized diagram is shown of wave reordering 400 that efficiently migrates the execution of threads between multiple parallel lanes of execution. In the illustrated implementation, a streaming wave coalescing (SWC) reorder instruction has been executed by lane of the one of the multiple waves and wave 430 (“Wave 2”) has been selected to be the emitting wave 430. The result of the SWC reordering is reordered wave 450 (“Wave 3”). To generate reordered wave 450, a SWC circuit of a compute circuit uses each of the contributing wave 410 (“Wave 0”) and contributing wave 420 (“Wave 1”). Examples of the circuitry that selects waves as contributing waves and the emitting wave and generates a reordered emitting wave are the circuitry of streaming wave coalescer (SWC) circuit 105 (of FIG. 1), SWC circuit 256 (of FIG. 2), and apparatus 300 (of FIG. 3). Each of the waves 410, 420 and 430 includes multiple lanes 402, each corresponding to a thread of the wave to be executed on one of the multiple parallel lanes of a vector processing circuit. In an implementation, each of the waves includes 32 lanes, 64 lanes, or other. For ease of illustration, each of the waves 410, 420 and 430 includes 8 lanes.

In some implementations, the SWC circuit uses the key (not shown) of the lane of a wave that initially executed the SWC reorder instruction and compares this key to keys of other lanes of other waves. In other implementations, another key of another lane of the wave or another lane of another wave is used for the comparisons. In the illustrated implementation, two waves have lanes with a key that matches the key of the SWC reorder instruction. In an implementation, the lane corresponding to lane 1 (W2L1) of original emitting wave 430 executed the SWC reorder instruction and its key is used in the comparisons.

In some implementations, local memory 440 is a level-zero (L0) cache. In other implementations, local memory 440 is dedicated data storage space in another type of memory. For each lane of the emitting wave 430 to be replaced, the SWC circuit stores a copy of the continuation state information (live active state information) of the lane from registers to local memory 440. The registers include registers of the scalar register file and the vector register file. As described earlier, this operation of generating the copy of the continuation state information in the temporary data storage location (local memory 440) is referred to as a “spill” or performing “spilling.” The SWC circuit performs the spill of the continuation state information after the SWC circuit has already completed identifying which lanes of execution of the multiple waves to swap between the multiple waves. This operation is referred to as performing the “spill-after” operation. Additionally, the SWC circuit performs the spill-after operation only for the lanes of the waves being swapped.

For each lane of the contributing waves 410 and 420 being used to replace lanes of the emitting wave 430, the SWC circuit stores active state information of the lane in local memory 440. In various implementations, the SWC circuit uses information stored in output 350 (of FIG. 3) to perform the data storage of the active state information. Once stored in local memory 440, in some implementations, the SWC circuit asserts a flag or other indicator, such as a “sticky” bit, that indicates the active state information is to be retained in local memory 440 until used, and the corresponding data storage locations, such as cache lines or other memory storage entries, are not candidates for eviction.

As shown, the SWC circuit uses the active state information of lane 4 specified by “W1L4” of contributing wave 420 (“Wave 1”) to replace the active state information of lane 0 specified by “W2L0” of emitting wave 430 (“Wave 2”). The key of the lane “W2L0” does not match the key of lane 1 “W2L1,” whereas the key of lane 4 “W1L4” matches the key of lane 1 “W2L1.” Similarly, the keys of lanes specified by “W1L5,” “W1L7,” “W0L0,” and “W0L1” have keys that match the key of lane 1 “W2L1.” However, the keys of lanes specified by “W2L3,” “W2L5,” “W2L6,” and “W2L7” do not have keys matching the key of lane 1 specified by “W2L1.”

In some implementations, the SWC circuit waits to perform the reordering until a number of lanes of contributing waves with a matching key is equal to or greater than a threshold. In various implementations, the SWC circuit executes the instructions of an exchange kernel that consists of a “Store Phase,” which is shown in wave reordering 400 (of FIG. 4) followed by a “Load Phase,” which is shown in wave reordering 500 (of FIG. 5). Coherency between the waves, such as waves 410, 420 and 430 and other waves (not shown) of the compute circuit and between the store phase and load phase is achieved via the use of a barrier instruction. Before each of the store phase and the load phase, the participating waves (contributing waves 410 and 420 and emitting wave 430) join the barrier.

In an implementation, during the “Store Phase,” the SWC circuit stores the continuation state (active live state information) of the lanes of the emitting wave 430 to be replaced in the upper half of local memory 440 at an offset calculated from the lane ID being replaced (e.g., “W2L0,” “W2L3,” “W2L5,” “W2L6,” and “W2L7”). The SWC circuit stores the continuation state (active live state information) of the lanes of the contributing waves 410 and 420 used to perform the replacements in the lower half of the local memory 440 at the same offset calculated from the lane ID of the lane being replaced. Once the participating wave has its state information stored, the SWC circuit has the participating wave wait on the barrier.

It is noted that in some implementations, the threshold number of lanes that have matching keys is set in a programmable configuration register to equal the total number of lanes of a wave. In the illustrated implementation, this threshold number is eight lanes. In other implementations, the threshold number is less than the total number of lanes of a wave and the threshold number is chosen based on design requirements such as reducing the duration of time to generate an emitting wave. Although the original emitting wave 430 is shown to have some lanes already using the key to match, such as W2L1, W2L2 and W2L4, it is also possible and contemplated that the selected original emitting wave has no lanes that use the key to match. It is also noted that one or more of the above steps for the “Store Phase” can be assigned by the SWC circuit to be implemented by other circuitry of the compute circuit. Additionally, instructions of firmware can be executed by one or more of the SWC circuit and other circuitry of the compute circuit to perform one or more of the above steps of the “Store Phase” and one or more steps of the “Load Phase” described further in the wave reordering 500 (of FIG. 5).

Turning now to FIG. 5, a generalized diagram is shown of wave reordering 500 that efficiently migrates the execution of threads between multiple parallel lanes of execution. Circuitry and components described earlier are numbered identically. As described earlier, in various implementations, the SWC circuit executes the instructions of an exchange kernel that consists of a “Store Phase,” which is shown in wave reordering 400 (of FIG. 4) followed by a “Load Phase,” which is shown in wave reordering 500 (of FIG. 5). In various implementations, the SWC circuit and other circuitry of the compute circuit perform one or more of the above steps of the “Store Phase” of wave reordering 400 (of FIG. 4) and one or more steps of the “Load Phase” of wave reordering 500. Additionally, instructions of firmware can be executed by one or more of the SWC circuit and other circuitry of the compute circuit to perform one or more of these steps. In the earlier description of wave reordering 400 (of FIG. 4) and the following description of wave reordering 500, the steps are described as being performed by the SWC circuit, but it is possible and contemplated that one or more steps are performed by other circuitry that can execute instructions of firmware or other software.

Once all participating waves (contributing waves 410 and 420 and emitting wave 430) have reached the barrier, the “Load Phase” starts. During the “Load Phase,” the SWC circuit or circuitry of the lanes in the emitting wave 430 with lanes being replaced perform read operations to load the continuation state (active live state information) from the corresponding lane of the contributing wave (contributing wave 410 or 420) by retrieving the state from local memory 440. As described earlier, the operation of retrieving the copy of the continuation state information from the temporary data storage location (local memory 440) and storing it in registers of a second SIMD circuit executing a second wave is referred as a “fill” or performing “filling.” In an implementation, the SWC circuit or the circuitry of the lanes reads the lower half of local memory 440 where the corresponding lane of the contributing wave (contributing wave 410 or 420) stored its continuation state (active live state information).

The SWC circuit or circuitry of the lanes of the contributing waves 410 and 420

read continuation state (active live state information) from the corresponding lane it is replacing from the upper half of local memory 440 where the corresponding lane of emitting wave 430 stored its continuation state (active live state information). Once the participating waves (contributing waves 410 and 420 and emitting wave 430) have stored their updated continuation state (active live state information), the lanes wait on a barrier instruction to provide synchronization. After the “Load Phase” (and the exchange) has completed, and the convergence point of the barrier instruction has been reached by each of the contributing waves 410 and 420, the SWC circuit can begin emitting another wave in the same workgroup.

Although the above steps for the “Store Phase” of wave reordering 400 (of FIG. 4) and the “Load Phase” of wave reordering 500 have been described as using one of a variety of types of local memory 440, it is possible and contemplated that the SWC circuit, circuitry of a lane of a wave, or other circuitry of the compute circuit performs these steps using only the data storage space of the register files of the compute circuit. When the SIMD circuits corresponding to the emitting wave and one of the contributing waves are in the same compute circuit and access the same register files, it is possible to perform the steps of the exchange of the continuation state information within the register files. As described earlier, hardware resources 257 of compute circuit 255A includes a scalar register file and one or more vector register files for vector processing circuits (SIMD circuits) 230A-230Q. Rather than use local cache 252, a level-zero (L0) cache (not shown), or other data storage space, SWC circuit 256 (or other circuitry) performs the exchange of continuation state information within the register files of hardware resources 257. SWC circuit 256 (or other circuitry) checks the available amount of data storage space to use in the register files and compares the amount of continuation state information to exchange. If there is sufficient data storage space in the register files of hardware resources 257, then SWC circuit 256 (or other circuitry) performs the exchange (the steps of the “Store Phase” and the “Load Phase”) within the hardware resources 257.

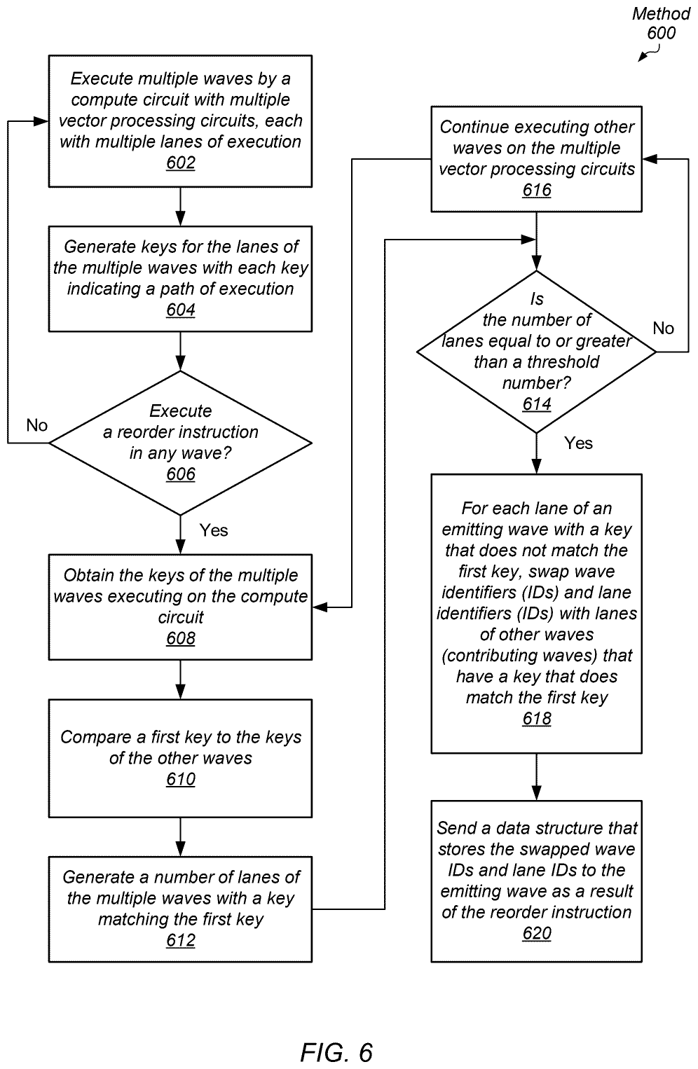

Referring to FIG. 6, a generalized diagram is shown of a method 600 for efficiently migrating the execution of threads between multiple parallel lanes of execution. For purposes of discussion, the steps in this implementation (as well as in FIG. 12) are shown in sequential order. However, in other implementations some steps occur in a different order than shown, some steps are performed concurrently, some steps are combined with other steps, and some steps are absent.

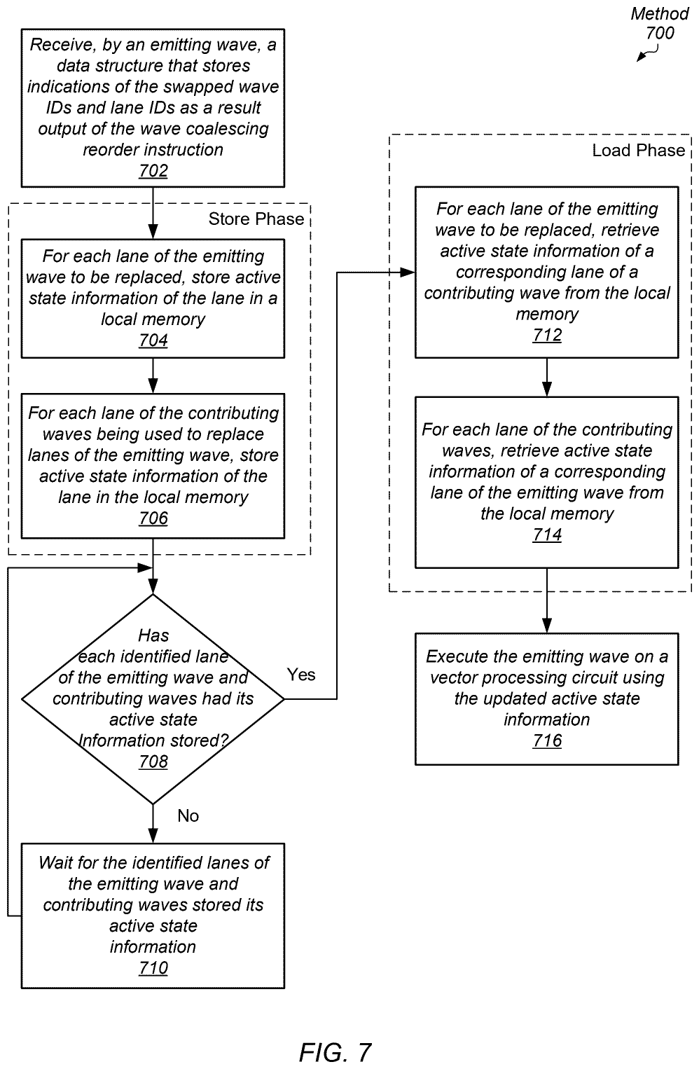

For each of methods 600-700 (of FIGS. 6-7), a computing system includes at least a first processing circuit and a second processing circuit. The first processing circuit is a host processing circuit such as a general-purpose processing circuit that executes a host operating system. An example of the first processing circuit is processing circuit 110 (of FIG. 1). The second processing circuit is a parallel data processing circuit has a highly parallel data microarchitecture. An example of the second processing circuit is processing circuit 102 (of FIG. 1) and apparatus 200 (of FIG. 2). The second processing circuit includes multiple compute circuits such as compute circuits 255A-255N (of FIG. 2). Each of these compute circuits includes a control circuit such as streaming wave coalescer (SWC) circuit 105 (of FIG. 1), SWC circuit 256 (of FIG. 2), and apparatus 300 (of FIG. 3).

A compute circuit with multiple vector processing circuits, each with multiple lanes of execution, executes multiple waves (block 602). The parallel data application being executed by the compute circuit generates keys for the lanes of the multiple waves with each key indicating a path of execution (block 604). If no lane of the multiple lanes of execution has not yet executed a streaming wave coalescing (SWC) reorder instruction (“no” branch of the conditional block 606), then control flow of method 600 returns to block 602 where the compute circuit executes multiple waves. However, if a lane of the multiple lanes of execution has executed the SWC reorder instruction (“yes” branch of the conditional block 606), then the SWC circuit obtains the keys of the multiple waves executing on the compute circuit (block 608). Examples of the keys (or sort keys) was provided earlier in the description of SWC circuit 105 (of FIG. 1), SWC circuit 256 (of FIG. 2), and apparatus 300 (of FIG. 3).

The SWC circuit compares a first key to the keys of the other waves (block 610). The SWC circuit generates a number of lanes of the multiple waves with a key matching the first key (block 612). If the number of lanes is less than a threshold number (“no” branch of the conditional block 614), then the compute circuit continues executing other waves on the multiple vector processing circuits (block 616). However, if the number of lanes is equal to or greater than the threshold number (“yes” branch of the conditional block 614), then for each lane of an emitting wave with a key that does not match the first key, the SWC circuit swaps wave identifiers (IDs) and lane identifiers (IDs) with lanes of other waves (contributing waves) that have a key that does match the first key (block 618). The SWC circuit selects one of the multiple waves to be the emitting wave based on design requirements. The SWC circuit sends a data structure that stores the swapped wave IDs and lane IDs to the emitting wave as a result of the wave coalescing reorder instruction (block 620).

Turning now to FIG. 7, a generalized diagram is shown of a method 700 for efficiently migrating the execution of threads between multiple parallel lanes of execution. An emitting wave executing on a lane of multiple parallel lanes of a vector processing circuit receives a data structure that stores indications of the swapped wave IDs and lane IDs as a result output of the wave coalescing reorder instruction (block 702). For example, the corresponding compute circuit performed the steps of method 600 (of FIG. 6). For each lane of the emitting wave to be replaced, the SWC circuit stores active state information of the lane in a local memory (block 704). In some implementations, the local memory is a level-zero (L0) cache. In other implementations, the local memory is dedicated data storage space in another type of memory.

For each lane of the contributing waves being used to replace lanes of the emitting wave, the SWC circuit stores active state information of the lane in the local memory (block 706). In various implementations, the SWC circuit uses information such as information stored in output 350 (of FIG. 3) to perform the data storage of the active state information. In some implementations, the SWC circuit asserts a flag or other indicator that the active state information is to be retained, and the corresponding data storage locations, such as cache lines, are not candidates for eviction.

If one or more of the identified lanes of the emitting wave and contributing waves has not yet had its active state information stored (“no” branch of the conditional block 708), then the SWC circuit waits for the identified lanes of the emitting wave and contributing waves stored its active state information (block 710). Afterward, control flow of method 700 returns to conditional block 708. However, if each identified lane of the emitting wave and contributing waves has its active state information stored (“yes” branch of the conditional block 708), then for each lane of the emitting wave to be replaced, the SWC circuit retrieves active state information of a corresponding lane of a contributing wave from the local memory (block 712). For each lane of the contributing waves, the SWC circuit retrieves active state information of a corresponding lane of the emitting wave from the local memory (block 714). Blocks 712-714 belong to a load phase of wave reordering. An illustration of the load phase was provided earlier in wave reordering 500 (of FIG. 5). The SWC circuit executes the emitting wave on a vector processing circuit using the updated active state information (block 716).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of vector processing circuits, each comprising circuitry of a plurality of lanes for executing instructions of a plurality of waves;
circuitry configured to:
responsive to a first lane executing a wave reordering instruction:
generate indications of a path of execution for at least a subset of the plurality of lanes; and
responsive to a number of lanes that have a same path of execution exceeding a threshold, exchange active state information between one or more pairs of lanes from at least two waves of the plurality of waves.

2. The apparatus as recited in claim 1, wherein the circuitry is configured to exchange the active state information within a register file of one of the plurality of vector processing circuits.

3. The apparatus as recited in claim 1, wherein the circuitry is configured to exchange the active state information within a data structure.

4. The apparatus as recited in claim 3, wherein the circuitry is configured to store an indication with the active state information that specifies no eviction of the active state information.

5. The apparatus as recited in claim 1, wherein the circuitry is configured to generate, as the indications of the path of execution, a plurality of keys, each key comprising at least a subset of an instruction pointer indicating the next instruction to execute.

6. The apparatus as recited in claim 5, wherein the circuitry is configured to compare keys of the plurality of keys corresponding to lanes of the plurality of lanes that have executed the wave reordering instruction.

7. The apparatus as recited in claim 5, wherein to exchange the active state information between the one or more pairs of lanes, the circuitry is configured to exchange active state information of each lane of an emitting wave with a key of the plurality of keys that does not match a first key of the first lane and active state information of each lane of a contributing wave with a key of the plurality of keys that matches the first key.

8. A method, comprising:
executing instructions of a plurality of waves by circuitry of a plurality of lanes of a plurality of vector processing circuits;
responsive to a first lane executing a wave reordering instruction:
generating, by circuitry, indications of a path of execution for at least a subset of the plurality of lanes; and
exchanging active state information between one or more pairs of lanes from at least two waves of the plurality of waves, responsive to a number of lanes that have a same path of execution exceeding a threshold.

9. The method as recited in claim 8, further comprising exchanging the active state information within a register file of one of the plurality of vector processing circuits.

10. The method as recited in claim 8, wherein the circuitry is configured to exchange the active state information within a data structure.

11. The method as recited in claim 10, further comprising storing an indication with the active state information that specifies no eviction of the active state information.

12. The method as recited in claim 8, further comprising generating, as the indications of the path of execution, a plurality of keys, each key comprising at least a subset of an instruction pointer indicating the next instruction to execute.

13. The method as recited in claim 12, further comprising comparing keys of the plurality of keys corresponding to lanes of the plurality of lanes that have executed the wave reordering instruction.

14. The method as recited in claim 12, wherein to exchange the active state information between the one or more pairs of lanes, the method further comprises exchanging active state information of each lane of an emitting wave with a key of the plurality of keys that does not match a first key of the first lane and active state information of each lane of a contributing wave with a key of the plurality of keys that matches the first key.

15. A computing system comprising:
a processing circuit comprising:
a plurality of lanes for executing instructions of a plurality of waves in parallel; and
circuitry configured to exchange active state information between one or more pairs of lanes from at least two waves of the plurality of waves, responsive to a number of lanes that have a same path of execution exceeding a threshold.

16. The computing system as recited in claim 15, wherein the circuitry is configured to exchange the active state information within a register file of one of the plurality of vector processing circuits.

17. The computing system as recited in claim 15, wherein the circuitry is configured to exchange the active state information within a data structure.

18. The computing system as recited in claim 17, wherein the circuitry is configured to store an indication with the active state information that specifies no eviction of the active state information.

19. The computing system as recited in claim 15, wherein the circuitry is configured to generate, as the indications of the path of execution, a plurality of keys, each key comprising at least a subset of an instruction pointer indicating the next instruction to execute.

20. The computing system as recited in claim 19, wherein to exchange the active state information between the one or more pairs of lanes, the circuitry is configured to active state information of each lane of an emitting wave with a key of the plurality of keys that does not match a first key of the first lane and active state information of each lane of a contributing wave with a key of the plurality of keys that matches the first key.
